(19) United States
(12) Patent Application Publication
(10) Pub. No.: US 2005/0208306 A1
(43) Pub. Date: Sep. 22, 2005

(54) Fabric side-finishing method and products

(76) Inventor: Angelo Rizzardi, Charlotte, NC (US)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/805,547

(22) Filed: Mar. 19, 2004

(51) Int. Cl. B32B 1/00

(52) U.S. Cl. 428/411.1; 427/209; 427/402; 427/430.1

(57) ABSTRACT

A process for forming a substrate having a desired performance finish or finishes applied thereto. The process involves applying a foam containing a selected performance finish to a selected substrate side in such a manner that the performance finish is inhibited from transpassing through the substrate to the opposed substrate side. Accordingly, the performance characteristic of the finish is exhibited only on the side of the substrate to which the finish was applied. Additionally, the process may involve applying a second foam having a second distinct performance finish to the opposed side of the substrate in such a manner that only the second side exhibits the characteristics of the second finish. Various parameters used to control transpassing of the finish through the substrate include, singularly and/or in combination, finishing bath chemistry, foam characterization, pH of the finishing bath and freezing moisture that is within the substrate.

### BACKGROUND OF THE INVENTION

1. Field of the Invention

The present invention relates generally to the field of fabric finishing and, more specifically, to a fabric finishing method for providing a distinct performance finish to a selected side of a fabric such that the fabric exhibits the performance characteristic of the finish on the side to which it was applied only and the product formed thereby.

2. Description of the Related Art

Performance finishes are applied to fabrics and/or substrates in order for the substrate to exhibit a distinct and desired effect. For example, fabrics and/or substrates may be caused to exhibit water repellency, oil repellency, water absorbency, antimicrobial properties, and permanent press characteristics by applying the respective performance finish thereto.

Prior art FIG. 1 illustrates a conventional process 10 for a performance finishing application technique for major types of fabric constructions, such as knits, woven and non-woven textiles. The process 10 includes the steps of providing a substrate 12, preparing the substrate 14, by removing impurities in the substrate and drying, as needed, and then padding the substrate 16 by passing it through a bath containing a selected performance finish so as to apply the finish to the substrate. Once the finish is applied, excess liquid in the substrate structure is removed by nipping 18, or applying vacuum pressure, to the substrate, and then by drying and curing 19.

Traditionally, padding was the preferred method for applying a performance finish to a substrate, particularly for thin substrates, as such are fairly simple to nip then dry. Other known methods for applying a finish, such as foam application, were considered unable to control foam penetration through the substrate and the uneven finish that would result there-from. Additionally, the performance finish would transpass throughout the entire substrate, causing the finishing characteristic to be exhibited on both surfaces of the substrate. As used throughout this application, the term “transpass” shall mean the migration of a performance finish from one surface of the fabric, into the fabric structure, and to the opposite surface.

Foam application processes have been used for non-woven fabrics where performance finish consistency and its transpassing throughout the substrate were not a concern. In conventional foam application, a finishing bath having a high percentage of water, by weight, was considered advantageous for forming the foam and for conveying it to the point of application. There was no consideration as to restricting the performance finish from transpassing through the substrate nor any practical means or method for controlling the amount of transpass. Accordingly, finish that was applied to one substrate surface transpassed into other substrate regions. Moreover, the finish would bleed through the substrate, causing the opposing surface to exhibit the same characteristic as the applied upon surface. However, it is not always desirable to have both surfaces sharing the same effect.

As such, the prior art has failed to recognize a need or use for a fabric finishing method that limits the transpassing of a performance finish through a substrate. Moreover, the prior art has failed to recognize the need or use of a fabric finishing process that produces a substrate that exhibits a performance characteristic on one side of the substrate and a separate and distinct performance finish on the opposed substrate side.

For example, in apparel, it may be preferred to have the exterior surface exhibit water repellency while having the interior surface exhibit characteristics such as, water absorbency, antimicrobial properties or special softening effects. As another example, it may be desirable for an article of clothing to be permanent press or wrinkle free, while the fabric interior exhibits features like a wicking effect in order to draw perspiration away from the wearer, or antimicrobial/odor prevention properties.

Another disadvantage of having the finish transpass throughout the substrate is that the finishing chemicals are absorbed into areas of the substrate where the effect is not needed or desired. A further problem is that finishing chemicals may have a detrimental effect on the substrate, such as reducing the tensile strength of the fabric. Accordingly, it would be preferred to limit the use of finishing chemicals to the portion of the substrate where the effect is desired, leaving the remaining portion of the substrate unaffected.

Since performance finishes enhance the quality, functionality, and ultimately the desirability of the fabric to the consuming public, there is, therefore, a need in the art to provide a process for controlling transpassing of a performance finish through an applied upon substrate. Further, there exists a need in the art for a finishing process that may be used on a variety of substrates, including apparel, which yields a fabric having separate and distinct performance finishes on opposed sides of the substrate.

### BRIEF SUMMARY OF THE INVENTION

To achieve the foregoing and other objects, the present invention, as embodied and broadly described herein, provides various embodiments of methods for finishing a substrate in order to have the substrate exhibit a desired effect. In specific embodiments, transpass of a finish through the substrate was controlled in order for the substrate to exhibit the effect only on the side to which the finish was applied. Various parameters used to control transpassing of the finish through the substrate include, singularly and/or in combination, finishing bath chemistry, foam characterization, pH of the finishing bath, freezing moisture that is within the substrate and other process steps as described herein.

In a preferred embodiment of the present invention, the method of finishing the fabric generally includes the steps of providing a substrate; applying a first finish having a first performance characteristic to the substrate; and controlling transpassing of the finish through the substrate so that the majority of the finish remains on the first side of the substrate as compared to the opposed second side of the substrate. Optionally, transpassing is controlled so that at least 75 weight % of the finish remains on the first side as compared to the second side.

By limiting transpassing of the finish through the substrate, the performance characteristic of the finish is exhibited with greater effectiveness on the applied upon side as compared to the opposed substrate side. In a preferred embodiment, the effectiveness of the characteristic on the non-applied side is less than 50% of the effectiveness on the applied upon substrate side.

A finishing bath having desired properties, from which foam is generated for application to a substrate, also contributes to limiting transpass of a finish through a substrate. In a preferred embodiment of the present invention, the finishing bath includes a finish and a 0.1-60 wt. % of a transpass-limiting ingredient. Optionally, the bath also has a viscosity that is at least 40 cp. As another option, the bath may have a pH in a range from pH 2 to pH 6.

The process also has practical use with thin substrates. That is, transpassing of a finish through a substrate may be limited even for substrates having a weight of 300 g/sq meter or less.

The various embodiments of the methods may be used to create a substrate having more finish, by weight, on the side that the finish was applied upon than on the opposed substrate side. Optionally, the applied upon side may have at least 75 wt. % of the finish within the substrate. Additionally, the applied upon side may exhibit the characteristic of the finish at an effectiveness greater than that exhibited on the opposed substrate side. For example, the effectiveness on the non-applied upon substrate side may be less than 50% of the effectiveness exhibited from the applied upon side.

### BRIEF DESCRIPTION OF THE DRAWINGS

The above described and other features, aspects, and advantages of the present invention are better understood when the following detailed description of the invention is read with reference to the accompanying drawings, wherein:

FIG. 1 is a flowchart of a prior art process for applying a performance finish to a substrate;

FIG. 2 is a flowchart of a process for finishing a substrate in accordance with an exemplary embodiment of the present invention;

FIG. 3 is a flowchart of an alternative process for finishing a substrate, wherein a first performance finish is applied to one side of the substrate and a separate and distinct performance finish is applied to the opposed substrate side, in accordance with an exemplary embodiment of the present invention; and

FIG. 4 is a flowchart of another alternative process for finishing a substrate wherein moisture within the substrate is frozen in order to control transpassing of a finish through the substrate, in accordance with an exemplary embodiment of the present invention.

### DETAILED DESCRIPTION OF THE INVENTION

The present invention will now be described more fully hereinafter with reference to the accompanying drawings in which preferred embodiments of the invention are shown. This invention may, however, be embodied in many different forms and should not be construed as limited to the embodiments set forth herein. These exemplary embodiments are provided so that this disclosure will be both thorough and complete, and will fully convey the scope of the invention to those skilled in the art.

The present invention describes a fabric finishing process for providing a distinct finish to a side of a substrate. In various embodiments, transpassing of the finish is controlled so that only the side to which the finish was applied exhibits the associated performance characteristic. That is, penetration of the applied finish is limited so that its effects are exhibited only on the applied upon side without affecting the normal character of the opposed side. The fabric finishing process may also be used to apply a first finish to a first side of a substrate and a second distinct finish to the opposed substrate side whereby the respective performance characteristics are exhibited only on the applied upon side.

The present invention also describes the products made from the invented finishing process. In various embodiments, a substrate is produced having a performance characteristic on a selected side without exhibiting the performance characteristic on the opposed side. In specific embodiments, a produced substrate may have a first performance finish on a first selected side and a second distinct performance finish on the opposed side, wherein the specific characteristic of each finish is exhibited only on the side to which the finish was applied.

Any finish having a desired performance characteristic may be used. For example, a selected performance finish may include, without limitation, attributes such as anti-microbial function, UV absorbency, cross-linking, permanent press, stain/soil resistance, stain/soil release, hydrophilic, hydrophobic, oleo-phobic, oleo-philic, surface mercerization, and the like.

The term “substrate” as used herein includes any type of fabric material, including knits, wovens and non-wovens. Further, the substrate may be made of any desired fiber composition. For example, the present invention has utility with various fibers including, without limitation, cotton, cotton-blends, synthetic fibers such as polyesters, polyamide, and other man-made and artificial fibers, and silk.

Furthermore, the present invention has application with substrates of any desired weight, whether thick or thin. For the purpose of this application, thick substrates are considered those having a weight greater than 300 g/sq meter. The term “thin substrate”, as used herein, shall be considered to be any substrate that has a weight of 300 g/sq meter or less, and more preferably having a weight in the range of 60 g/sq meter to 300 g/sq meter. As such, the present invention has application to all kinds of apparel, including thin cotton fabrics for men's and women's shirts, typically about 100 g/sq meter, and pants, typically about 250 g/sq meter.

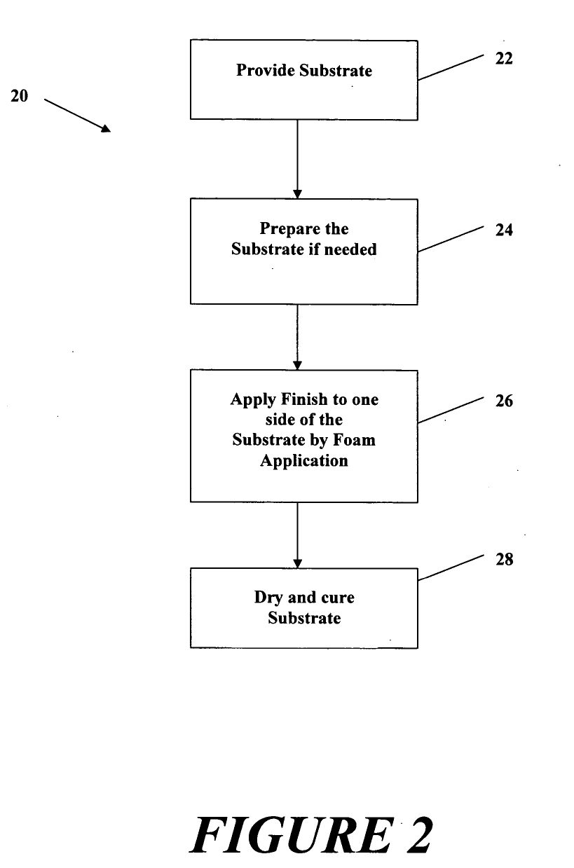

Referring to FIG. 2, the present invention 20 includes the steps of providing a substrate 22, preparing the substrate 24, applying a desired performance finish to a side of the substrate 26, and drying and curing the substrate 28, as needed.

The substrate is prepared in a conventional manner. For example, the substrate may be scoured to remove size, oils and other impurities. Additionally, the substrate is prepared for being absorbent as fiber/substrate absorbency is an important parameter for achieving the best possible two sided effect definition as well as for achieving the best possible level of permanency for a given applied finish. Moreover, where oil and/or water repellency are required, the fiber/fabric absorbency is obtained ideally with no surface tension active chemical remaining on the substrate. The substrate may also be dyed in advance of applying a performance finish in order to achieve a pre-determined color, using any conventional dyeing method including, but not limited to, continuous, semi-continuous, and exhaust dyeing processes.

The pre-selected performance finish is applied to a side of the substrate by foam application. The applied foam has a composition comprised of a desired performance finish, an ingredient limiting the transpass of the finish, a foaming agent having minimum wetting power so as to reduce potential transpassing, and water. While not wishing to be bound by theory, these components are believed to interact, impacting the half life, wick-ability, blow-ratio and viscosity of the foam so as to inhibit transpass of the finish through the substrate.

The transpass-limiting ingredient of the finishing composition may be chosen from a variety of polymers, including but not limited to, salts of polyacrylates, poly-ols, poly-carboxylates, poly-carbohydrates, etc. The presence of such ingredient may or may not alter the viscosity of the composed foam bath aggressively. And, although the type and the amount of the ingredient may affect foam-ability, the selected polymer will be such that it will not hamper the finishing bath composition from obtaining a suitable blow-ratio. A certain molecular weight distribution of the chosen polymer type would be preferred for the sake of the function of inhibiting the transpass without jeopardizing other required foam quality/qualities. The pH of the chosen polymer may be within a certain preferred range and the amount of electrolytes associated with the polymer may be limited for not hampering desired performance. Without limitation, the foaming agent may be chosen for example, from amine oxides.

As known to those skilled in the art, the foam is generated from a finishing bath and may be applied by any conventional manner of foam application including contact deposition by a foam generator and a foam applicator. Thus, the finishing bath composition is a foam composition subsequent to foaming. One suitable foam generator and applicator that may be utilized in the present invention may be obtained from Gaston Systems, located in Stanley, N.C.

The foam may be characterized in terms such as blow ratio, half life, wick-ability and bath viscosity. The term “blow ratio” shall mean the amount of air within the foam composition compared to the amount of finishing bath composition, by volume. The blow ratio may practically be 2:1 to 40:1, and beyond. Preferably, the blow ratio is at least 6:1, more preferably at least 8:1, and most preferably in the range of 8:1 to 20:1.

The term “half life” shall mean the time in which it takes for half of the foam composition to return to a liquid state, by weight. In general, the longer the half life, the more control that is achieved over transpassing of the finish through the substrate. Preferably, the half life of the foam is at least 5 minutes, more preferably at least 20 minutes, even more preferably at least 30 minutes, and most preferably in the range of 30 minutes to 2½ hours.

Another characteristic of the foam that is unique to this invention is its low wick-ability, as compared to conventional foams. As used, herein, the term “wick-ability” shall mean the vertical migration of liquid from the foam onto the substrate and shall be examined in the manner that one end of a fabric strip is dipped into the foam at a depth of one inch for one minute. The sample is then removed from the foam and air dried. Any liquid wicking from the foam above the one inch mark is observed and recorded for comparison use. By having a low wick-ability, transpass of the applied finish through the substrate is reduced. In addition of selection of surfactants of minimum wetting power, the slow rate of foam wick-ability is due largely to the transpass-limiting ingredients, which are preferably comprised in the finish bath composition at a percentage in the range of 0.1% to 60%, and more preferably in a range from 5% to 30%, by weight, depending on the chosen product and its components.

The transpass-limiting ingredient may also cause the finishing bath viscosity to increase. In general, the higher the bath viscosity the slower the transpassing rate of the finish through the substrate and, accordingly, the greater the ability to limit the finish to the applied upon side. In practice finishing bath viscosity is ultimately limited in that a finishing bath having an extremely high viscosity may be hampered from achieving acceptable foam-ability and foam uniformity. The preferred viscosity is at least 10 cp, more preferably at least 40 cp, and most preferably in a range from 50 cp to 1000 cp, as measured by a Brookfield Viscometer.

As to finishing chemicals themselves, where cationic products are chosen for the desired performance finishing effects on cotton and cellulosic fabrics, increasing their positive charges by optimizing the level of the acidic pH in the finishing bath will greatly improve the nontranspassing feature of the finishing. The increased positive charges of the cation(s) will be attracted by negative charges of the cotton and other cellulosic fibers in presence of water and minimize any transpassing of the cationic chemicals in the foam. The kinetic speed of such a reaction is faster than the diffusion speed of the water through the fabric.

Although, in general, the finishing bath may have any pH, from 1 to 14, Applicant has found that when cationic products are used, the preferred pH is in a range from pH 2 to pH 6, and most preferred in a range from pH 3.5 to pH 5.

Subsequent to the application of the foam, the substrate may simply be air dried. However, typically the substrate will be subjected to drying and/or curing operations 28. It will be understood by those skilled in the art that any conventional manner for drying a substrate after application of a performance finish may be employed, such as by passing the substrate through an oven, heat zone or other type of dryer.

Unconventionally, drying and/or curing of the substrate may be achieved by blowing air, preferably heated, onto the substrate side that is opposed to the foam applied side. In addition to achieving drying/curing, the force of the blown air from the non-applied side may be beneficial for arresting transpassing of the finish through the substrate.

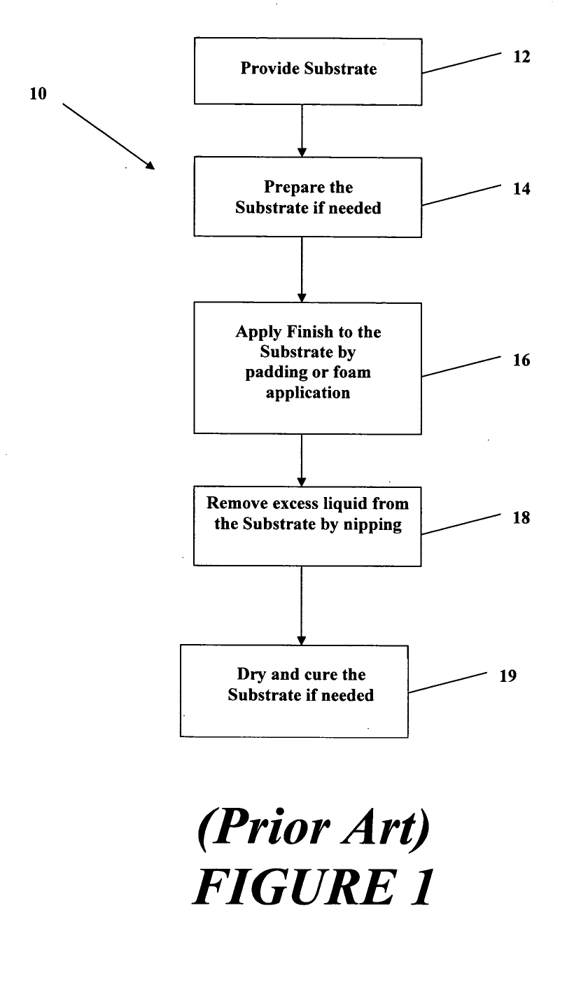

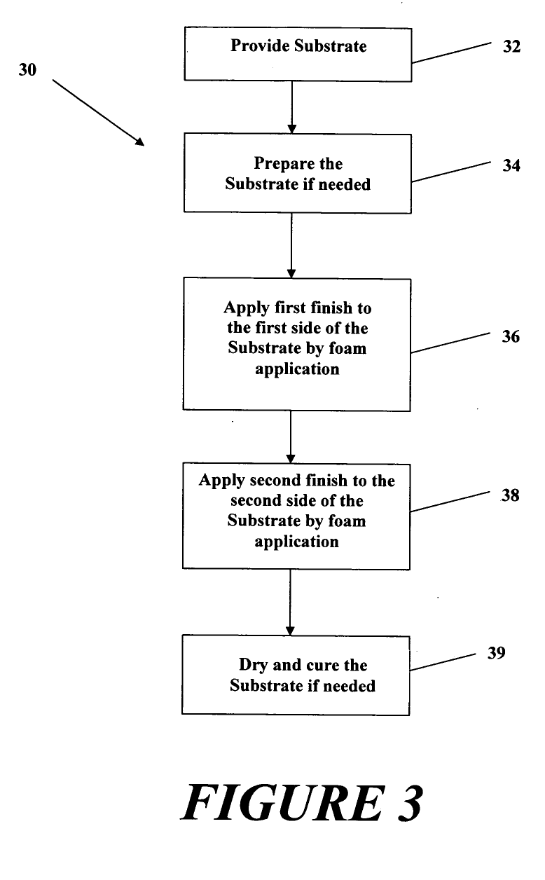

Referring to FIG. 3, an alternative embodiment of the present invention is shown 30. The illustrated substrate finishing method 30 applies distinct foam finishes on opposed sides of a substrate, resulting in a product that exhibits separate performance characteristics on its opposed sides. The method 30 comprises the steps of providing and preparing a substrate 32, 34 as previously discussed with reference to FIG. 1. Thereafter, a foam having a first desired performance finish is applied to a first substrate side 36, and a second foam containing a second desired performance finish is applied to the opposed substrate side 38.

Both foams may be simultaneously applied to their respective side or the first foam may be applied to the first substrate side and then the second foam is applied to the opposed second side. The foam composition and its method of application are as previously described with reference to FIG. 2. For example, the foam includes a performance finish, a transpass-limiting ingredient, a foaming agent and water, as discussed above. And, the foam may be applied to the substrate by pressure contact deposition techniques, or the like.

Thereafter, the substrate may be further processed by drying and/or curing the substrate in the same manner as discussed in reference to FIG. 2. In a slight variation from the previous embodiment, an additional process step is needed to account for the second finish if the substrate is to be dried and/or cured by side-air blowing. As with the previous embodiment, the first foam is applied to the first substrate side after which hot air is blown onto the second side. Thereafter, and in addition, the second foam is applied to the second substrate side and then hot air is blown onto the first side.

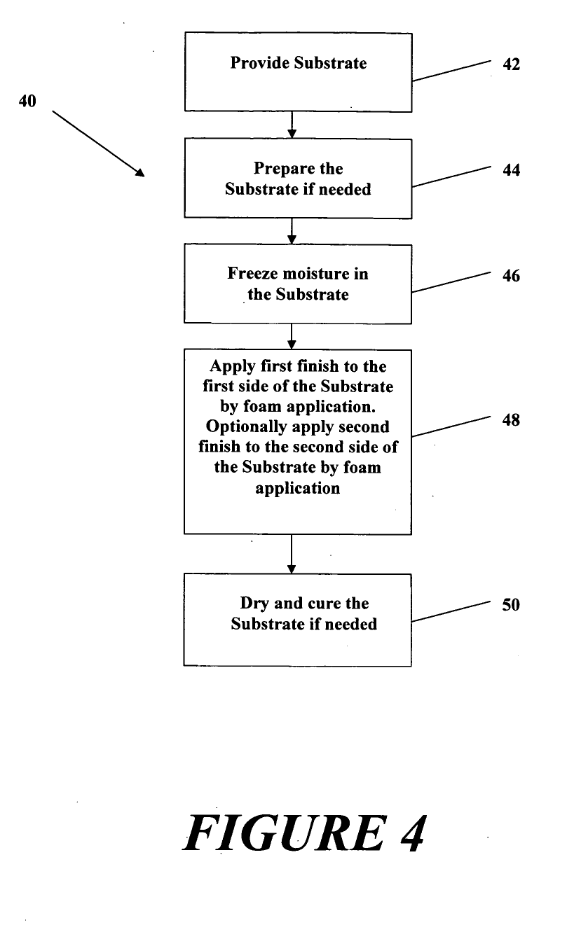

Referring to FIG. 4, another embodiment of the present invention 40 is illustrated wherein any of the previously described embodiments may further include the step of freezing moisture that is present within the substrate prior to applying finishing foam to the substrate.

The process 40 includes the steps of providing a substrate 42, preparing the substrate 44, freezing moisture within the substrate 46, applying a first foam containing a first selected performance finish to a first side of the substrate and optionally applying a second foam containing a second selected performance finish to a second substrate side 48, and then drying and/or curing the substrate 50, as needed. In a preferred form, the application of the second foam to a second substrate side 48 is performed simultaneously with the application of the first foam to the first substrate side. Aside from freezing moisture in the substrate, each of the process steps and also the characteristic of the applied foam are as discussed above, and, as such, are not discussed hereat in further detail.

By freezing the moisture, penetrability of the substrate is decreased due to the temporary icy barrier and, accordingly, transpass of the performance finish is inhibited. Another advantage of freezing moisture in the substrate is that wet pick-up of the foam may be reduced, resulting in less chemicals being absorbed into the substrate. Applicant has found that the performance of the finish and its permanency, despite an average lower wet pick-up, are comparable to the results obtained by using the other invented embodiments described herein. It is theorized that this desirable result is achieved due to the icy barrier limiting the finish from transpassing beyond its region of use.

Any suitable means may be used to freeze moisture in the substrate. For example, the substrate may be passed through a chamber containing nitrogen, or nitrogen blanket, in order to freeze moisture within the substrate. Preferably, the substrate is passed through a temperature zone that is 0° C. or less, more preferably in a range from 0° C. to −120° C., and most preferably in a range from −30° C. to −100° C.

The substrate is subjected to the freezing temperature for a period of time such that a sufficient amount of moisture within the substrate is frozen in order to provide a desired barrier against transpassing of the finish. The required period of time is typically in the range of 1 second to 100 seconds, and preferably in the range of 3 seconds to 25 seconds.

The concept of creating a temporary barrier in order to decrease the penetrability of the substrate may encompass other means and methods, such as pre-treating the substrate with water, steam, or physically emulsified system based on water and a water-immiscible solvent before freezing the substrate.

The above described methods may be used to produce a substrate having a distinct performance finish that is substantially disposed in the side of the substrate to which the finish had been applied. That is, the substrate may include a first performance finish or finishes that is substantially disposed in the first substrate side and/or a second performance finish or finishes that is substantially disposed in the opposed second side of the substrate. As used herein, the term “side” shall mean a portion of the substrate that is ½ of the substrate, as viewed in cross-section. As such, the terms “first side” and “second side” respectively refer to opposing halves of the substrate. Moreover, the term “substantially” as used herein shall mean more than 50% of the finish by weight, more preferably at least 75% of the finish by weight, and most preferably at least 90% of the finish by weight.

The produced substrate is distinguished by having a distinct performance characteristic exhibited principally on the substrate side in which the finish is disposed. That is, the effectiveness of the performance characteristic exhibited on the opposed substrate side is less than the effectiveness exhibited on the disposed side. Preferably the effectiveness on the opposed side is less than 50%, more preferably less than 25%, and most preferably less than 10% of the effectiveness of the disposed side. Accordingly, the substrate may exhibit a first performance characteristic or characteristics on a first substrate side and a separate second performance characteristic or characteristics on a second substrate side. This side differentiation is possible even with incompatible finishes. For example, a hydrophobic finish may be applied to the first substrate side and, because the applied finish does not transpass to the opposed side, a hydrophilic finish may be applied to the second side.

As it will be appreciated by those skilled in the art of fabric finishing, some performance finishes have effectiveness beyond the area to which the finish is provided. For example, in a thin substrate, a finish having anti-microbial functionality will have effectiveness not only on the side that the finish is disposed, but also on the opposed substrate side due to the diffusive mechanism of the finish. As another example, a wrinkle resistant resin that is applied to a thin substrate may also cause the opposed substrate side to be wrinkle resistant. However, since transpassing of the finish is controlled to substantially remain on the applied upon substrate side, there is no interference with the application of a second finish, even if incompatible with the first finish, to the opposed substrate side.

### EXPERIMENT 1

A bleached cotton woven shirting fabric from a commercial source, of weight about 107 g/sq meter was provided in 2 pieces to form Samples A and B as described below. Each sample was prepared and cleaned in a conventional manner prior to application of any finish. The listed percentages of the foam and bath constituents are by weight.

Sample A: The sample was untreated, but was tested for wicking behavior in a foam. The foam was formed with 30% Nuva HPU (a perfluorocarbon product available by the Clariant Corporation, Charlotte, N.C.), 2% Afilan KC (an amine oxide available by the Clariant Corporation, Charlotte, N.C.), and 68% water, at blow ratio 10/1. The foam was characterized with a bath viscosity of 14 cp, and a foam half life of about 6 minutes. This wicking evaluation was conducted in the manner that one end of the sample was dipped into the foam for one inch length for one minute. And then the sample was removed from the foam and allowed to be air-dried. Any liquid wicking above the one inch mark was observed and recorded into Table 1.

Sample B: The sample was untreated, but was tested for wicking behavior in a foam that includes a transpass-limiting ingredient. The foam was formed with 30% Nuva HPU (a perfluorocarbon product available by the Clariant Corporation, Charlotte, N.C.), 15% SR1429 (a sodium polyacrylate), 2% Afilan KC (an amine oxide available by the Clariant Corporation, Charlotte, N.C.), and 53% water, at blow ratio 10/1. The foam was characterized with a bath viscosity of 60 cp, and a foam half life of about 45 minutes. The wicking evaluation was conducted in the same manner as Sample A. Any liquid wicking above the one inch mark was observed and recorded into Table 1.

TABLE 1

| | |
|---|---|
| Sample | Wicking behavior |

| | | |
|---|---|---|
| Sample A | In a foam that contains | Wicked about 5 |
| (Conventional) | no transpass-limiting | millimeter |
| | ingredient | |
| Sample B | In a foam that contains | No wicking |
| (Present Invention) | transpass-limiting | |
| | ingredient | |

As illustrated by Tables 1, the use of a finishing foam having a transpass-limiting ingredient in accordance with the present invention reduced transpassing of the finish through fabric as compared to conventional finishing foam.

### EXPERIMENT 2

A bleached cotton woven shirting fabric from a commercial source, of weight about 107 g/sq meter was provided in 3 pieces to form Samples C-E as described below. Each sample was prepared and cleaned in a conventional manner prior to application of any finish. The listed percentages of the foam and bath constituents are by weight.

Sample C: The sample was untreated and tested for hydrophobicity by utilizing a drop test. The drop test was conducted in the manner set forth in AATCC Test Method 79: Absorbency of Bleached Textiles. The observation was recorded into Table 2.

Sample D: Sample D was foam-applied to one side (Side A) of the fabric in accordance with a prior art method. The foam was formed with 30% Nuva HPU (a perfluorocarbon product available by the Clariant Corporation, Charlotte, N.C.), 2% Afilan KC (an amine-oxide available by the Clariant Corporation, Charlotte, N.C.), and 68% water, at blow ratio 10/1. The foam was characterized with a bath viscosity of 14 cp, and a foam half life of about 6 minutes. The application of the foam finish resulted in about 15% wet pick-up. Subsequent to the application of the foam finish, Sample D was dried and cured at 180° C. for 45 seconds. Once Sample D was processed, it was tested for hydrophobicity on both sides (Side A and Side B) by water drop test. The water drop test was conducted in the manner set forth in AATCC Test Method 79: Absorbency of Bleached Textiles. The observation was recorded into Table 2.

Sample E: Sample E was foam-applied to one side (Side A) of the fabric, with a foam that contained a transpass-limiting ingredient, in accordance with the present invention. The foam was formed with 30% Nuva HPU (a perfluorocarbon product available by the Clariant Corporation, Charlotte, N.C.), 15% SR1429 (a sodium polyacrylate), 2% Afilan KC (an amine oxide available by the Clariant Corporation, Charlotte, N.C.), and 53% water, at blow ratio 10/1. The foam was characterized with a bath viscosity of 60 cp, and a foam half life of about 45 minutes. The application of the foam finish resulted in about 15% wet pick-up. Subsequent to the application of the foam finish, Sample E was dried and cured at 180° C. for 45 seconds. Once Sample E was processed, it was tested for hydrophobicity on both sides (Side A and Side B) by water drop test. The water drop test was conducted in the manner set forth in AATCC Test Method 79: Absorbency of Bleached Textiles. The observation was recorded into Table 2.

TABLE 2

| | Wetting time/drop test | | |
|---|---|---|---|
| Sample | Side A | Side B | Results/observation |
| Sample C | 10-30 | 10-30 seconds | Both sides demonstrate a |
| (Untreated) | seconds | | certain degree of |
| | | | absorbency |
| Sample D | Completely | Completely | Foam finish transpassed |
| (Conventional) | hydrophobic | hydrophobic | to non-applied side |
| Sample E | Completely | 10-30 seconds | Foam finish did not |
| (Present | hydrophobic | | transpass to non-applied |
| Invention) | | | side |

As illustrated by Table 2, transpassing of the finish was controlled by using the present invention. As a result, the finishing characteristic was exhibited only on the selected foam applied side of the fabric.

### EXPERIMENT 3

Plain woven polyester fabric of textured yarn of about 184 g/sq meter was provided in three pieces to form Samples F-H as described below. Each sample was prepared and cleaned in a conventional manner used to prepare woven polyester fabrics prior to application of any finish and had a hydrophobic nature after rinsing surfactant residue from previous preparatory steps. The listed percentages of the foam and bath constituents are by weight.

Sample F: Sample F was untreated and tested for water absorbency by utilizing a drop test. The drop test was conducted in the manner set forth in AATCC Test Method 79: Absorbency of Bleached Textiles. The observation was recorded into Table 3.

Sample G: Sample G was foam-applied to one side (Side A) of the fabric for hydrophobicity in accordance with the present invention. The foam was formed with 30% Nuva HPU (a perfluorocarbon product available by the Clariant Corporation, Charlotte, N.C.), 10% SR 1429 (a sodium polyacrylate), 4% Acusol-882 (a hydrophobically modified nonionic polyol available by Rohm and Haas Company, Philadelphia, Pa.), 2% Afilan KC (amine oxide available by the Clariant Corporation, Charlotte, N.C.), and 54% water, at a blow ratio 10/1. The foam was characterized by a bath viscosity of 730 cp, and a foam half life of longer than 60 minutes. The application of the foam finish resulted in about 10% wet pick-up. Subsequent to the application of the foam finish, Sample G was dried and cured at 180° C. for 45 seconds. Once Sample G was processed, it was tested for water absorbency on both sides (Side A and Side B) by a water drop test. The water drop test was conducted in the manner set forth in AATCC Test Method 79: Absorbency of Bleached Textiles.

Sample H: Sample H was foam-applied to one side (Side A) of the fabric for hydrophobicity and foam-applied to the opposed side (Side B) for hydrophilicity, in accordance with the present invention. The foam of Side A was formed with 30% Nuva HPU (a perfluorocarbon product available by the Clariant Corporation, Charlotte, N.C.), 10% SR 1429 (a sodium polyacrylate), 4% Acusol-882 (a hydrophobically modified nonionic polyol), 2% Afilan KC (amine oxide available by the Clariant Corporation, Charlotte, N.C.), and 54% water, at a blow ratio 10/1. The foam was characterized by a bath viscosity of 730 cp, and a foam half life of longer than 60 minutes. The application of the foam resulted in about 10% wet pick-up. The sample was dried at 120° C. The foam of Side B was formed with 50% Milease T liq. (a polyester dispersant available by the Clariant Corporation, Charlotte, N.C.), 0.5% Afilan KC, 1% Pentex FC, and 48.5% water, at blow ratio 10/1. The foam was characterized by a bath viscosity of 68 cp, and a foam half life of about 20 minutes. The application of the foam resulted in about 10% wet pick-up. Subsequent to the application of the foam finishes, Sample H was dried and cured at 180° C. for 45 seconds. Once Sample H was processed, it was tested for water absorbency on both sides (Side A and Side B) by water drop test. The test was conducted in the manner set forth in AATCC Test Method 79: Absorbency of Bleached Textiles. The observation was recorded into Table 3.

TABLE 3

| | | | Wetting time/ | Wetting time/ | |
|---|---|---|---|---|---|
| | Treatment | Treatment | drop test | drop test | |
| Sample | (Side A) | (Side B) | (Side A) | (Side B) | Results/Observations |
| Sample F | N/A | N/A | ≈10 min | ≈10 min | Both sides demonstrate |
| (Untreated) | | | | | a slow wicking property |
| Sample G | Hydrophobic | N/A | Completely | ≈10 min | Side A is hydrophobic; |
| (Present | formula | | hydrophobic | | Side B demonstrates a |
| Invention) | | | | | slow wicking property |
| Sample H | Hydrophobic | Hydrophilic | Completely | 1-3 sec. | Side A is hydrophobic; |
| (Present | formula | formula | hydrophobic | absorption | Side B demonstrates an |
| Invention) | | | | time | increased hydrophilic |
| | | | | | property |

As illustrated by Table 3, the finish was limited to one side of the fabric by using the present invention. As a result, a separate finish, and distinct from the first finish, was able to be applied to the opposed side of the fabric.

### EXPERIMENT 4

A bleached cotton woven shirting fabric from a commercial source, of weight about 107 g/sq meter was provided in 3 pieces to form Samples I-K as described below. Each sample was prepared and cleaned in a conventional manner prior to application of any finish. The listed percentages of the foam and bath constituents are by weight.

Sample I: Sample I was untreated and tested for hydrophilicity by wicking behavior. The wicking test was conducted in the manner that one end of the sample was immersed into a wicking solution consisting of tap water with red tint for one inch length for one minute. And then the sample was removed from the wicking solution and air-dried. Any liquid wicking above the one inch mark was observed and recorded into Table 4.

Sample J: Sample J was treated for hydrophobicity using conventional padding, and was tested for wicking behavior. The finishing bath was formed with 4% Nuva HPU (a perfluorocarbon product available by the Clariant Corporation, Charlotte, N.C.), 2% SR 1429 (a sodium polyacrylate product available by Stockhausen, Inc., Greensboro, N.C.), 0.27% Afilan KC (an amine oxide available by the Clariant Corporation, Charlotte, N.C.), and 93.73% water. The padding resulted in about 76% wet pick-up. Subsequent to padding, Sample J was dried and cured at 180° C. for 60 seconds. Once Sample J was processed, it was tested for wicking behavior on both sides (Side A and Side B) in the same manner as Sample I. Any liquid wicking above the one inch mark was observed and recorded into Table 4.

Sample K: Sample K was foam-applied to one side (Side A) of the fabric for hydrophobicity in accordance with the present invention. The foam was formed with 30% Nuva HPU (a perfluorocarbon product available by the Clariant Corporation, Charlotte, N.C.), 15% SR1429 (a sodium polyacrylate), 2% Afilan KC (an amine oxide available by the Clariant Corporation, Charlotte, N.C.), and 53% water, at blow ratio 10/1. The foam was characterized with a bath viscosity of 60 cp, and a foam half life of about 45 minutes. The application of the foam finish resulted in about 15% wet pick-up. Subsequent to the application of the foam finish, Sample K was dried and cured at 180° C. for 45 seconds. Once Sample K was processed, it was tested for wicking behavior on both sides (Side A and Side B) by a wicking test. Any liquid wicking above the one inch mark was observed and recorded into Table 4.

TABLE 4

| | | Wicking | | Wicking | | |
|---|---|---|---|---|---|---|
| Sample | Treatment | (Side A) | | (Side B) | | Results/Observations |
| Sample I | N/A | ≈16 | mm | ≈16 | mm | No side differentiation; |
| (Untreated) | | | | | | Both sides hydrophilic |
| Sample J | Conventional | 0 | mm | 0 | mm | No side differentiation; |
| (Conventional) | Padding/ | | | | | Both sides hydrophobic |
| | Hydrophobic | | | | | |
| | formula | | | | | |
| Sample K | Hydrophobic | 0 | mm | ≈15 | mm | Side A is hydrophobic; |
| (Present | formula | | | | | Side B is hydrophilic |
| Invention) | (Side A) | | | | | |

As illustrated by Table 4, transpassing of the finish was controlled by using the present invention. As a result, the finishing characteristic was exhibited only on the selected foam applied side of the fabric.

### EXPERIMENT 5

A bleached cotton woven shirting fabric from a commercial source, of weight about 107 g/sq meter was provided in 3 pieces to form Samples L-N as described below. Each sample was prepared and cleaned in a conventional manner prior to application of any finish. The listed percentages of the foam and bath constituents are by weight.

Sample L: Sample L was untreated and tested for wrinkle resistance and tensile breaking strength loss. The wrinkle resistance test was conducted in the manner set forth in AATCC Test Method 128-1989, Wrinkle Recovery of Fabrics: Appearance Method. The sample was rated from 1 (worst wrinkle resistance) to 5 (best wrinkle resistance, full wrinkle recovery). The sample was also tested for tensile breaking strength loss in the warp direction by utilizing a tensile breaking strength loss test. The test was conducted in the manner set forth in ASTM-D5034-1995 using an Instron Tensile tester, Model No. 4301, available by Instron, Inc., Canton, Mass. The observations were recorded into Table 5.

Sample M: Sample M was treated for wrinkle resistance using conventional padding. The finishing bath was formed with 10% Freerez-845 (a self-catalyzed buffered durable press reactant from Noveon Inc., Cleveland, Ohio), and 90% water, at pH 3.9. The padding resulted in about 97% wet pick-up. Subsequent to padding, Sample M was dried at 120 C for 45 seconds and cured at 180° C. at 30 seconds. Once Sample M was processed, the sample was tested for wrinkle resistance and tensile breaking strength loss in the manner as Sample L. The observations were recorded into Table 5.

Sample N: Sample N was foam-applied for oil and water repellency to one side (Side A) of the fabric, and foam-applied for wrinkle resistance to the other side (Side B) of the fabric, in accordance with the present invention. The foam of Side A was formed with 60% Nuva HPU (a perfluorocarbon product available by the Clariant Corporation, Charlotte, N.C.), 7% SR1429 (a sodium polyacrylate), 2.5% Afilan KC (an amine oxide available by the Clariant Corporation, Charlotte, N.C.), and 30.5% water, at blow ratio 10/1. The foam was characterized with a bath viscosity of 100 cp, and a foam half life of about 30 minutes. The application of the foam finish resulted in about 15% wet pick-up. Subsequent to the application of the foam finish, Sample N was dried at 120 C for 45 seconds. The foam of Side B was formed with 30% Freerez-845 (a self-catalyzed resin), 10% SR 1429 (a sodium polyacrylate), 0.8% Afilan KC (an amine oxide), and 59.2% water, at blow ration 10/1. The application of this foam finish resulted in about 15% wet pick-up. Subsequent to the application of the foam finishes, the fabric was dried and cured at 190° C. for 25 seconds. Once Sample N was processed, the fabric was tested for wrinkle resistance and tensile breaking strength loss in the manner as Sample L. The observations were recorded into Table 5.

TABLE 5

| | | | Wrinkle | | |
|---|---|---|---|---|---|
| | Treatment | Treatment | resistance | Tensile | |
| Sample | (Side A) | (Side B) | rating | strength loss | Results/Observations |
| Sample L | N/A | N/A | ≈1 | N/A | |
| (Untreated) | | | | | |
| Sample M | Conventional | | ≈3 for both | 45% | Considerable loss of |
| (Conventional) | Padding/Resin | | sides | | tension strength |
| Sample N | Hydrophobic/ | Resin | ≈4 for both | 21% | Greater amount of |
| (Present | Oleophobic | formula | sides | | tensile strength |
| Invention) | formula | | | | preserved while |
| | | | | | rendering a high |
| | | | | | degree of wrinkle |
| | | | | | resistance |

As illustrated by Table 5, transpassing of the finish was controlled by using the present invention as evidenced by a reduction in amount of fabric tensile strength loss that is commonly associated with resin application. As a result, a separate finish, distinct from the first finish, was able to be applied to the opposed side of the fabric. It is noted that even though the resin was controlled to Side B, the finishing characteristic was exhibited on both sides due to the thinness of the fabric. Sample N had a higher wrinkle resistance rating than Sample M due to the fact that Side A formula for Sample N contains a different cross-linker. It is believed that Side A was rendered hydrophobic thereby contributing to wrinkle resistance.

### EXPERIMENT 6

A bleached cotton woven shirting fabric from a commercial source, of weight about 107 g/sq meter was provided in 3 pieces to form Samples O-Q as described below. Each sample was prepared and cleaned in a conventional manner prior to application of any finish. The listed percentages of the foam and bath constituents are by weight.

Sample O: The sample was untreated and tested for oil repellency. The oil repellency test was conducted in the manner set forth in AATCC Test Method 118-1992, an American National Standard, wherein an oil repellency of 5 denotes a high degree of resistance. The observation was recorded into Table 6.

Sample P: Sample P was padded through a finishing bath having an oleophobic finishing ingredient and tested for oil repellency. The finishing bath was formed with 4% Nuva HPU (a perfluorocarbon product available by the Clariant Corporation, Charlotte, N.C.), 0.027% Afilan KC (an amine oxide available by the Clariant Corporation, Charlotte, N.C.), and 93.73% water. The padding resulted in about 76% wet pick-up. Subsequent to padding, Sample P was dried and cured at 180° C. for 60 second. Once Sample P was processed, it was tested for oil repellency for both sides (Side A and Side B). The oil repellency test was conducted in the manner set forth in AATCC Test Method 118-1992, an American National Standard. The observation was recorded into Table 6.

Sample Q: Sample Q was foam-applied to one side (Side A) of the fabric, with a foam containing an oleophobic finishing ingredient. The foam was formed with 30% Nuva HPU (a perfluorocarbon product available by the Clariant Corporation, Charlotte, N.C.), 15% SR1429 (a sodium polyacrylate), 2% Afilan KC (an amine oxide available by the Clariant Corporation, Charlotte, N.C.), and 53% water, at blow ratio 10/1. The foam was characterized with a bath viscosity of 60 cp, and a foam half life of about 45 minutes. The application of the foam finish resulted in about 15% wet pick-up. Subsequent to the application of the foam finish, Sample Q was dried and cured at 180° C. for 45 seconds. Once Sample Q was processed, it was tested for oil repellency for both sides (Side A and Side B) by an oil repellency test. The oil repellency test was conducted in the manner set forth in AATCC Test Method 118-1992, an American National Standard. The observation was recorded into Table 6.

TABLE 6

| | | Oil | Oil | |
|---|---|---|---|---|
| | | repellency | repellency | |
| | Treatment | Grade | Grade | |
| Sample | (Side A) | (Side A) | (Side B) | Results/Observations |
| Sample O | N/A | 0 | 0 | No side differentiation; |
| (Un- | | | | Both sides oleophilic |
| treated) | | | | |
| Sample P | Conventional | 5.5 | 5.5 | No side differentiation: |
| (Conven- | Padding/ | | | Both sides oleophobic |
| tional) | Oleophobic | | | |
| | formula | | | |
| Sample Q | Oleophobic | 5 | 0 | Side A is oleophobic; |
| (Present | formula | | | Side B is oleophilic |
| Invention) | (Side A) | | | |

As illustrated by Table 6, transpassing of the finish was controlled by using the present invention. As a result, the finishing characteristic was exhibited only on the selected foam applied side of the fabric.

### EXPERIMENT 7

A bleached cotton knit shirting fabric from a commercial source, of weight about 175 g/sq meter was provided in 2 pieces to form Samples R-S as described below. Each sample was prepared and cleaned in a conventional manner prior to application of any finish. The listed percentages of the foam and bath constituents are by weight.

Sample R: The sample was untreated and tested for hydrophobicity by utilizing a drop test in accordance with the method set forth in AATCC Test Method 79: Absorbency of Bleached Textiles. The sample was also tested for anti-microbial functionality by evaluating observation of growth pattern of a microbial species, Staphylococcus aureus, in contract with the test samples. The anti-microbial test was conducted in the manner set forth in AATCC Test Method 147: Antibacterial Activity Assessment of Textile Materials: parallel Streak Method. The observations were recorded into Table 7.

Sample S: Sample S was foam-applied to one side (Side A) of the fabric with a foam that contained a water repellency ingredient and foam-applied to the other side (Side B) with a foam that contained an anti-microbial functionality. The foam of Side A was formed with 75% Nuva HPU (a perfluorocarbon product available by the Clariant Corporation, Charlotte, N.C.), 15% SR1429 (a sodium polyacrylate), 1% Genagen CAB-818 (a product of alkylamidopropylbetaine available by the Clariant Corporation, Charlotte, N.C.), 1% SR1429 (a sodium polyacrylate), 1% Alcogum-1370 (a sodium polyacrylate product, available by Alco Chemical, Inc. Chattanooga, Tenn.), and 23% water, at blow ratio 10/1. Sample was dried at 120° C. after the application to Side A. The foam of Side B was formed with 30% Santized T96-f21 (an anti-microbial product available by the Clariant Corporation, Charlotte, N.C.), 10% Binder MTB (a polyacrylate), 4% Genagen CAB-818 (an amine oxide), and 56% water. Subsequent to the application of the foam on Side B, Sample S was dried and cured at 180° C. for 30 seconds. Once Sample S was processed, it was tested for hydrophilicity for both sides (Side A and Side B) by a water drop test. The water drop test was conducted in the manner set forth in AATCC Test Method 79: Absorbency of Bleached Textiles. The observation was recorded into Table 7. Sample S was also tested for anti-microbial function on both sides (Sides A and Side B) by evaluating observation of growth pattern of a microbial species, Staphylococcus aureus, in contract with the test samples. The anti-microbial test was conducted in the manner set forth in AATCC Test Method 147: Antibacterial Activity Assessment of Textile Materials: parallel Streak Method. The observations were recorded into Table 7.

TABLE 7

| | | | Absorbency/ | Absorbency/ | Anti- | |
|---|---|---|---|---|---|---|
| | Treatment | Treatment | Drop test | Drop test | microbial | Results/ |
| Sample | (Side A) | (Side B) | (Side A) | (Side B) | effect | Observations |
| Sample R | N/A | N/A | Instantly | Instantly | Weak | No side |
| (Untreated) | | | absorbed | Absorbed | growth on | differentiation |
| | | | | | both sides | |
| Sample S | Hydrophobic | Anti- | No | Instantly | No growth | Side A is |
| (Present | formula | microbial | absorbency | Absorbed | for both | hydrophobic; |
| Invention) | | formula | | | sides | Side B is |
| | | | | | | hydrophilic |
| | | | | | | with anti- |
| | | | | | | microbial |
| | | | | | | finish that is |
| | | | | | | effective to |
| | | | | | | both sides |

As illustrated by Table 7, transpassing of the finish was controlled by using the present invention, as evidenced by the ability to apply the anti-microbial finish to the side opposite of where the hydrophobic finish was applied. It is noted that even though the anti-microbial finish was controlled to Side B, the finishing characteristic was exhibited on both fabric sides due to the diffusive mechanism of the finish.

Following two experiments further emphasize the importance of the proper balance between the described foam characterization, selection of transpassing limiting ingredients and pH of the finishing bath where cationic components are used.

### EXPERIMENT 8

A bleached cotton woven shirting fabric from a commercial source, of weight about 107 g/sq meter was provided in 2 pieces to form Samples T-U as described below. Each sample was prepared and cleaned in a conventional manner prior to application of any finish. The listed percentages of the foam and bath constituents are by weight.

Sample T: The sample was treated with a formula containing oleophobic perfluorocarbon finish on Side A and tested for oil repellency on both Side A and Side B. The formula included 30% Nuva HPU (a perfluorocarbon product available from Clariant Corporation, 4000 Monroe Road, Charlotte, N.C.), 13% Acumer 1540 (a homopolymer of acrylic acid available from Rohm and Haas Company, 100 Independence Mall West, Philadelphia, Pa.), 0.5% Afilan KC (an amine oxide, from Clariant Corporation), 0.5% Hostapur Dad (an nonionic surfactant, from Clariant Corporation), and 56% water. And the bath was adjusted to pH 7. The foam was characterized with a bath viscosity of 63 cp, and blow ratio 10 to 1, no wicking occurred when one end of the fabric sample dipped into the foam for one inch length for one minute. The application of the foam finish resulted in about 10 tol 5% wet pick-up. Subsequent to the application of the foam finish, Sample T was dried and cured at 180 C for 45 seconds. The oil repellency test was conducted in the manner set forth in AATCC Test Method 118-1992. The observation was recorded into Table 8.

Sample U: The sample was also treated with a formula containing oleophobic perfluorocarbon finish on Side A and tested for oil repellency on both Side A and Side B. The formula included 30% Nuva HPU (a perfluorocarbon product available from Clariant Corporation, 4000 Monroe Road, Charlotte, N.C.), 13% Acumer 1540 (a homopolymer of acrylic acid available from Rohm and Haas Company, 100 Independence Mall West, Philadelphia, Pa.), 0.5% Afilan KC (an amine oxide, from Clariant Corporation), 0.5% Hostapur Dad (an nonionic surfactant, from Clariant Corporation), and 56% water. And the bath was adjusted to pH 4 instead of 7. The foam was characterized with a bath viscosity of about 50 cp, and blow ratio 10 to 1, no wicking occurred when one end of the fabric sample dipped into the foam for one inch length for one minute. The application of the foam finish resulted in about 13% wet pick-up. Subsequent to the application of the foam finish, Sample U was dried and cured at 180 C for 45 seconds. The oil repellency test was conducted in the manner set forth in AATCC Test Method 118-1992. The observation was recorded into Table 8.

TABLE 8

| | | | Oil | Oil | |
|---|---|---|---|---|---|
| | | | repellency | repellency | |
| | Adjusted | Pick-up | Grade | Grade | Results/ |
| Sample | bath pH | % | (Side A) | (Side B) | Observations |
| Sample T | 7 | 10 to 15 | 7 | 3 to 5 | Both sides |
| | | | | | oleophobic |
| Sample U | 4 | 13 | 6 | 0 | Side A is |
| | | | | | oleophobic; |
| | | | | | Side B is |
| | | | | | oleophilic |

In the formula used above, Nuva HPU is slightly cationic. Table 8 proves the very significant impact of the pH on a given combination of a lightly cationic component and a chosen polymer in a selected formula. The other parameters are fulfilled but in this case the full optimization of the two sides effect also requires the right pH adjustment.

### EXPERIMENT 9

Same as Experiment 8, but one of the important parameters, foam wicking on the substrate, for achieving a good characterization of the two sides effect has been intentionally worsened. The given formula displayed a wicking foam above the optimum specification for facilitating transpassing, by deliberately using half amount of Acumer 1540 as in EXPERIMENT 8. The foams had wicking about 2.5 to 3 mm on the substrate when one end of the sample was dipped into the foams for one inch length for one minute. All others were kept same as in EXPERIMENT 8. Results were listed in Table 9. Here too, the pH adjustment on the acidic side provides a very significant improvement of the two sides characterization.

TABLE 9

| | | | Oil | Oil | |
|---|---|---|---|---|---|
| | | | repellency | repellency | |
| | Adjusted | | Grade | Grade | Results/ |
| Sample | bath pH | Pick-up % | (Side A) | (Side B) | Observations |
| Sample V | 7 | 5 to 15 | 7 | 4 to 5 | Both sides |
| | | | | | oleophobic |
| Sample W | 4 | 8 to 15 | 6 | 0 | Side A is |
| | | | | | oleophobic; |
| | | | | | Side B is |
| | | | | | oleophilic |

For Sample W, although Side A and Side B had clear-cut oleophobic/oleophilic difference, the difference in hydrophilicity of Side A and Side B was much less compared to Sample U in Table 8, Experiment 8. That is, Side B of Sample U in Experiment 8 had good hydrophilicity, while Side B of Sample W, Experiment 9 had much worse hydrophilicity due to deliberately created wicking foam.

The foregoing methods provide a substrate having a distinct performance finish(es) on one side and/or a separate performance finish(es) on the opposed substrate side. Substrates made in accordance with the present invention are particularly useful in the manufacture of all types of apparel, including but not limited to shirts, pants, jackets, jerseys, skirts, dresses, hats, gloves, scarves, socks, undergarments, towels, etc.

The foregoing provides a detailed description of exemplary embodiments of the present invention. Although a substrate having a distinct performance finish or finishes on a side and method of making the same have been described with reference to preferred embodiments and examples thereof, other embodiments and examples may perform similar functions and/or achieve similar results. All such equivalent embodiments and examples are within the spirit and scope of the present invention and are intended to be covered by the following claims.

1. A process for providing a substrate with a finish, including the steps of:
providing a substrate having first and second sides;
providing a first finish having a first performance characteristic;
applying the first finish onto the first side of the substrate; and
limiting transpassing of the first finish through the substrate so that more of the first finish, by weight, remains disposed in the first side than in the second side.

2. The process in accordance with claim 1 wherein at least 75 wt. % of the first finish within the substrate remains disposed in the first side.

3. The process in accordance with claim 1 wherein the substrate has a weight of 300 g/sq meter or less.

4. The process in accordance with claim 2 further including the steps of providing a second finish having a second performance characteristic; applying the second finish onto the second side; and limiting transpassing of the second finish through the substrate so that at least 75 wt. % of the second finish within the substrate remains disposed in the second side.

5. The process in accordance with claim 1 further including the step of exhibiting the first performance characteristic principally in the first side.

6. The process in accordance with claim 5 further including the step of exhibiting the first performance characteristic on the second side at an effectiveness that is less than 50% of the effectiveness being exhibited on the first side.

7. The process in accordance with claim 6 wherein the substrate has a weight of 300 g/sq meter or less.

8. The process in accordance with claim 6 further including the steps of providing a second finish having a second performance characteristic; applying the second finish onto the second side; and exhibiting the second performance characteristic on the first side at an effectiveness that is less than 50% of the effectiveness being exhibited on the second side.

9. The process in accordance with claim 1 further including the steps of providing a finishing bath that includes a transpass-limiting ingredient in the range from 0.1-60 wt. % of the bath and the first performance finish; forming a foam from the bath; and applying the foam to the first side of the substrate.

10. The process in accordance with claim 9 wherein the transpass-limiting ingredient is in a range from 5-30 wt. % of the bath.

11. The process in accordance with claim 9 wherein the finishing bath has a viscosity that is at least 40 cp.

12. The process in accordance with claim 9 wherein the finishing bath has a viscosity that is in a range from 50 cp to 1000 cp and wherein the transpass-limiting ingredient is in a range from 5-30 wt % of the bath.

13. The process in accordance with claim 9 wherein the finishing bath has a pH in a range from pH 2 to pH 6.

14. The process in accordance with claim 10 wherein the foam has a half life greater than 20 minutes.

15. The process according to claim 1 further comprising the step of freezing moisture within the substrate.

16. A substrate having first and second sides prepared by a process comprising the steps of:
applying a first finish having a first performance characteristic onto the first side; and
limiting transpassing of the first finish through the substrate so that more of the first finish, by weight, remains disposed in the first side than in the second side.

17. The substrate according to claim 16 wherein at least 75 wt % of the first finish remains disposed in the first side.

18. The substrate according to claim 17 wherein the substrate has a weight of 300 g/sq meter.

19. The substrate according to claim 17 further including the steps of applying a second finish onto the second side and limiting transpassing of the second finish through the substrate so that at least 75 wt. % of the second finish within the substrate remains in the second side.

20. The substrate according to claim 16 further comprising the steps of exhibiting the first performance characteristic on the second side at an effectiveness that is less than 50% of the effectiveness being exhibited on the first side.

21. The substrate according to claim 20 further comprising the steps of applying a second finish having a second performance characteristic onto the substrate; limiting transpassing of the second finish through the substrate so that at least 50 wt. % of the second finish remains disposed on the second side; and exhibiting the second performance characteristic on the first side at an effectiveness that is less than 50% of the effectiveness exhibited on the second side.

22. The substrate according to claim 16 further comprising the step of freezing moisture within the substrate.

23. The substrate according to claim 16 further comprising the steps of forming a foam from a finishing bath, wherein the bath composition includes the first finish and 0.1-60 wt. % of a transpass-limiting ingredient; and applying the foam to the substrate.

24. The substrate according to claim 23 wherein the finish bath has a viscosity that is at least 40 cp.

25. The substrate according to claim 23 wherein the finishing bath has a pH in a range from pH 2 to pH 6.

26. A substrate having first and second sides, comprising: a substrate having a first finish wherein more than 50 wt. % of the first finish is disposed in the first side.

27. The substrate in accordance with claim 26 wherein at least 75 wt. % of the first finish is disposed in the first side.

28. The substrate in accordance with claim 27 further comprising a second finish wherein more than 75 wt. % of the second finish is disposed in the second side.

29. The substrate in accordance with claim 26 wherein the first finish has a first performance characteristic and wherein the first performance characteristic is exhibited on the second side at an effectiveness that is less than 50% of the effectiveness exhibited on the first side.

30. The substrate in accordance with claim 29 further comprising a second finish having a second performance characteristic wherein more than 50 wt. % of the second finish is disposed on the second side, and wherein the second performance characteristic is exhibited on the first side at an effectiveness that is less than 50% of the effectiveness exhibited on the second side.

31. The substrate in accordance with claim 26 wherein the substrate has a weight of 300 g/sq meter or less.

32. A finishing composition, comprising 0.1-60 wt. % transpass-limiting ingredient.

33. The composition of claim 32 wherein said transpass-limiting ingredient is in a range from 5-30 wt. %.

34. The composition of claim 32 wherein the composition has a viscosity that is at least 40 cp.

35. The composition of claim 32 wherein the composition has a viscosity that is in a range from 50 cp-1000 cp.

36. The composition of claim 32 wherein the composition has a pH in a range from pH2 to pH 6.
